(19) United States
(12) Patent Application Publication
(10) Pub. No.: US 2007/0153372 A1
(43) Pub. Date: Jul. 5, 2007

(54) Fluorescence illumination method and apparatus for stereomicroscopes

(75) Inventor: Charles Mazel, Bedford, MA (US)

Correspondence Address: SYNNESTVEDT LECHNER & WOODBRIDGE LLP, P O BOX 592, 112 NASSAU STREET, PRINCETON, NJ, 08542-0592, US

(73) Assignee: Physical Sciences, Inc., Andover, MA (US)

(21) Appl. No.: 11/324,464

(22) Filed: Jan. 3, 2006

(51) Int. Cl. G02B 21/06

(52) U.S. Cl. 359/385; 359/368

(57) ABSTRACT

The invention provides a fluorescence illumination adapter capable of being fitted to a wide range of existing stereomicroscopes. The fluorescence illumination adapter attaches to the stereomicroscope barrel that contains the imaging optics, and has high intensity light-emitting diodes that stimulate fluorescence in a specimen. A removable barrier filter is positioned in the optical path underneath the stereomicroscope barrel to prevent the fluorescence stimulating light entering the imaging optics. The light-emitting diodes are mounted on pivoting elements so that the location of the illumination spot on the specimen can be easily adjusted. The adapter also incorporates a white light-emitting diode source that can be used either for white-light viewing or for selective mixing with the fluorescence excitation illumination. The barrier filter is easily removed to facilitate rapid switching between fluorescence and white-light viewing.

### FEDERALLY SPONSORED RESEARCH

The United States Government may have rights in this invention under Contract DG133R-04-CN-0152 between the Department of Commerce (National Oceanic and Atmospheric Administration) and Physical Sciences Inc.

### FIELD OF THE INVENTION

This invention relates to systems and methods for providing an illumination adapter for stereomicroscopes, and more specifically to a removable adapter that converts a standard, visible light stereomicroscope into an external illumination, fluorescence stereomicroscope.

### BACKGROUND OF THE INVENTION

Many scientific, educational, and industrial disciplines benefit from fluorescence microscopy techniques for enhanced visualization.

The fluorescence to be viewed may result from a number of sources, including but not limited to: naturally occurring fluorophores in the samples under investigation; molecular fluorescent tags that bind to features of interest; proteins of the green fluorescent protein family that are used to trace expression of genes; and dyes such as fluorescein that are injected to trace blood flow in the retina or other portions of the body.

Because of their relatively low cost and great utility stereomicroscopes, many of them quite old, are found in many research and teaching laboratories. Researchers who want to add a fluorescence capability to their existing stereomicroscope currently have their options limited to making an ad hoc solution from individual components, purchasing a new stereomicroscope equipped with fluorescence capability, or purchasing a fluorescence adapter for an existing stereomicroscope.

The last option is, however, limited because adapters are only available for specific makes or models of stereomicroscopes, mostly of recent vintage. Microscope manufacturers typically only offer adapters for their own lines, and third-party manufacturers offer adapter models tailored to specific models of stereomicroscopes. Furthermore, when fluorescence is being used to view subjects any non-fluorescing subjects in the field of view will not be clearly visible. It can be useful to mix a controlled amount of white light illumination with the fluorescence excitation to achieve a mixed reflected-light and fluorescence image, and this capability is not provided with existing adapters.

Most systems for adapting a stereomicroscope for fluorescence provide a means to channel the excitation light into the objectives to achieve what is called epifluorescence illumination. This involves inserting an optical element between the eyepieces and the objectives, which requires engineering adapters that are specific to the stereomicroscope to be converted. For instance, U.S. Pat. No. 6,147,800 granted to Faber on Nov. 14, 2000 entitled “Fluorescence stereo microscope illuminator”, the contents of which are hereby incorporated by reference, is assigned to Kramer Scientific Corporation and describes a fluorescence adapter for stereomicroscopes that channels excitation light into both objectives. Adapters of this design are available from Kramer Scientific for specific stereomicroscope models. These adapters do not include the capability to mix white light and fluorescence excitation light.

There are known in the art other approaches to implementing fluorescence capability for stereomicroscopes. Some of these are provided by stereomicroscope manufacturers for specific models and are integrated into the stereomicroscope. An example is the Olympus SZX-RFL3 fluorescence adapter for the Olympus Model SZX12 stereomicroscope, both supplied by Olympus Europa GmbH of Hamburg, Germany. This fluorescence adapter is not available for stereomicroscopes of other manufacturers, and can not be retrofitted to older instruments.

Fluorescence adapters that provide the excitation light via a light source mounted on a stand next to the stereomicroscope stage are also known. Any illuminator mounted on a stand separate from the microscope has the disadvantage that it takes up valuable laboratory counter space, and can easily be knocked out of position by the operator while using the microscope controls or otherwise working in the vicinity of the microscope. Furthermore, these do not provide a convenient means of positioning the needed barrier filter in the emitted light path.

The value of universal adapters for fluorescence is recognized in, for instance, U.S. Pat. No 5,349,468 issued to Rathbon et al. on Sep. 20, 1994 entitled “Adapter for microscope”, the contents of which are hereby incorporated by reference. This patent does not apply to stereomicroscopes, but describes a universal approach for adapting conventional compound microscopes for fluorescence viewing. The approach described in this patent is only suitable for microscopes having a single operational objective and could not be used with stereomicroscopes.

Fluorescence illumination adapters for stereomicroscopes that provide epifluorescence illumination through the objectives are available only for limited, specific models of stereomicroscope. General-purpose solutions provided by illumination sources on stands external to the stereomicroscope take up bench space and are easily knocked out of alignment. Furthermore, these provide no convenient way of adding a barrier filter to the optical path. None of the available adapter systems provides a means of selectively mixing white-light illumination with the fluorescence excitation to better clarify the context in which the fluorescence is found.

### SUMMARY OF THE INVENTION

Briefly described, the invention relates to a system, method and apparatus for adapting an existing stereomicroscope for fluorescence microscopy. The adapter of this invention has several advantages, including being readily fitted to most existing stereomicroscopes, of being compact and unobtrusive, and of facilitating viewing by fluorescence and white light illumination simultaneously.

In a preferred embodiment, these advantages may be realized in the following manner.

The main body of the adapter may have a central hole that is large enough to fit over the largest, common stereomicroscope barrels. The body may be adapted to fit smaller diameters by various means such as thumbscrews, spring-loaded screws, or inserts of smaller inside diameter. The main body supports at least one, but preferably two or more, high intensity Light Emitting Diode (LED) light sources capable of exciting fluorescence. These light sources capable of exciting fluorescence may be pivot-mounted so as to be adjustably, rotatably attached to the main body so able to provide optimal illumination for fluorescence viewing at all viewing magnifications of the stereomicroscope. The fluorescence light sources may also be pivot out of the way if desired.

In addition to the light sources capable of exciting fluorescence, the main body supports a pivot-mounted white LED that provides white-light illumination and is adjustably, rotatably attached to the main body. This enables the user to either mix white light in with the fluorescence excitation or easily switch between fluorescence and white-light viewing modes without removing the entire adapter. In a preferred embodiment, the emission barrier filter may be a material such as glass or plastic, having suitable optical and mechanical properties, that is attached magnetically underneath the hole in the main body so as to be easily removed. Small magnets, for instance, may be inset into the underside of the main body, and strips of metal that can be held by those magnets are attached to the upper surface of the barrier filter. The strength of the magnets is chosen so that the filter is held securely during use but may be easily removed.

An additional piece of emission barrier filter is mounted to the back surface of the illuminator that will be in the front of the stereomicroscope when the adapter is installed. This acts as a light shield so that the user does not look directly at the bright excitation illumination spot on the stereomicroscope sample stage.

The LEDs are controlled by an external unit containing the switches and circuitry needed to energize the white or fluorescence excitation LEDs separately or together, and a means to control the intensity of the white light.

These and other features of the invention will be more fully understood by references to the following drawings.

### BRIEF DESCRIPTION OF THE DRAWINGS

FIG. 1 is a perspective view of the adapter mounted to a typical stereomicroscope.

FIG. 2 is a perspective view of the adapter alone.

FIG. 3 is graph showing the transmission spectrum of a yellow emission barrier filter.

FIG. 4 is a bottom elevational view of the adapter showing the inset magnets for holding the emission barrier filter.

FIG. 5 is a top elevational view of the barrier filter showing the attached metallic strips.

FIG. 6 is a side cross-sectional view of one of the illuminator elements.

FIG. 7 is an elevational view of one of the illuminator assemblies in its mounting bracket on the adapter.

FIG. 8 is a schematic drawing showing the adapter connected to a control box and power supply.

### DETAILED DESCRIPTION

The present invention relates to fluorescence illumination adapters that enable a wide range of stereomicroscopes to be used for fluorescence imaging. In a preferred embodiment the fluorescence illumination adapter can accommodate a variety of stereomicroscope barrel diameters and allows simultaneous fluorescence excitation and white light illumination of a specimen using high intensity light-emitting diodes (LEDs).

The potential to use high intensity LEDs instead of the arc discharge light sources traditionally used for fluorescence excitation has been described in several places, including the article entitled “LED fluorescence microscopy in theory and practice” by E. Silk published in the Proceedings and Presentations of the First Annual Citizen Science Conference, Philadelphia, Pa., June 28-29 by the Society for Amateur Scientists, East Greenwich, R.I. (2002), the article entitled “Improvements in fluorescence microscopy allowed by high power light emitting diodes” by G. Mazzini et al. in Current Issues on Multidisciplinary Microscopy Research and Education (ISBN 84-609-6605-4), pp. 181-188, edited by A. Méndez-Vilas and published as FORMATEX Microscopy Book Series by the Formatex Research Centre, Badajoz, Spain (2004), U.S. Pat. No. 6,154,282 issued to Lilge et al. on Nov. 28, 2000 entitled “Semiconductor based excitation illuminator for fluorescence and phosphorescence microscopy”, and PCT patent applications PCT/US01/05107 entitled “Fluorescence microscopy methods and devices using light emission diode” by Barsky et al, published as WO 01/61324 on 16 Feb. 2001 and PCT/IB2004/000976 by M. Angelini entitled “Lighting assembly for a luminescence analysis apparatus, in particular a fluorescence microscope, and luminescence analysis apparatus equipped with such a lighting assembly” published as WO 2004/088387 on 31 Mar. 2004, the contents of all of which are hereby incorporated by reference. All of these references describe means for substituting LEDs for traditional light sources in compound microscopes, and not stereomicroscopes. In most cases (the exception is Silk) the means is to insert the LED source in the same optical path as the original excitation source, thus providing epi-illumination. The adapters must therefore be engineered to fit specific models of microscope. Silk also describes the potential to use LEDs mounted on a table-mounted articulating arm to provide external oblique illumination. Such an implementation is awkward because it occupies valuable bench space and is easily knocked out of position. Moreover, none of the techniques described in these documents are suitable as general purpose adapters.

A preferred embodiment of the invention will now be described by reference to the accompanying drawings in which, as far as possible, like numbers identify like elements.

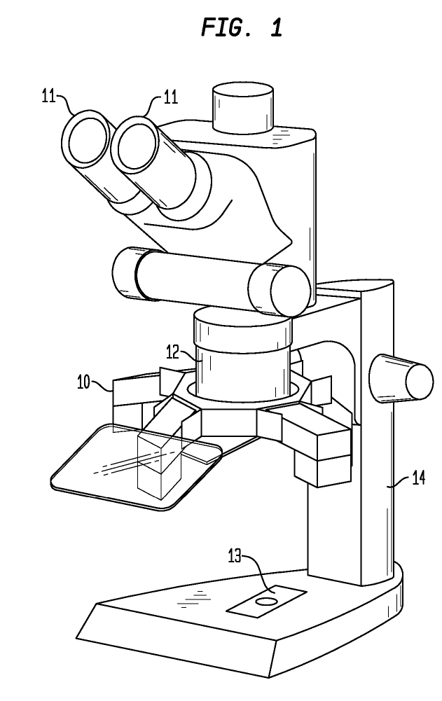

FIG. 1 shows a perspective view of a fluorescence illumination adapter 10, that is in accordance with a preferred embodiment of the invention, attached to the barrel 12 of a representative, typical stereomicroscope 14. The stereomicroscope is shown being used to view a specimen 13. The barrel 12 and the eye pieces 11 contain the stereomicroscope's imaging optics.

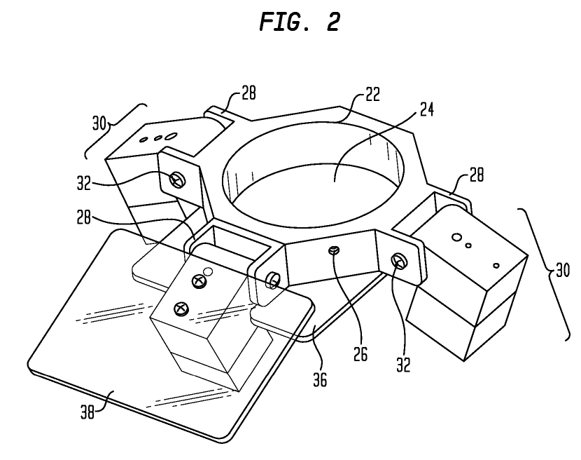

FIG. 2 shows, in greater detail, a perspective view of a fluorescence exciting illumination adapter 10 that is in accordance with a preferred embodiment of the invention.

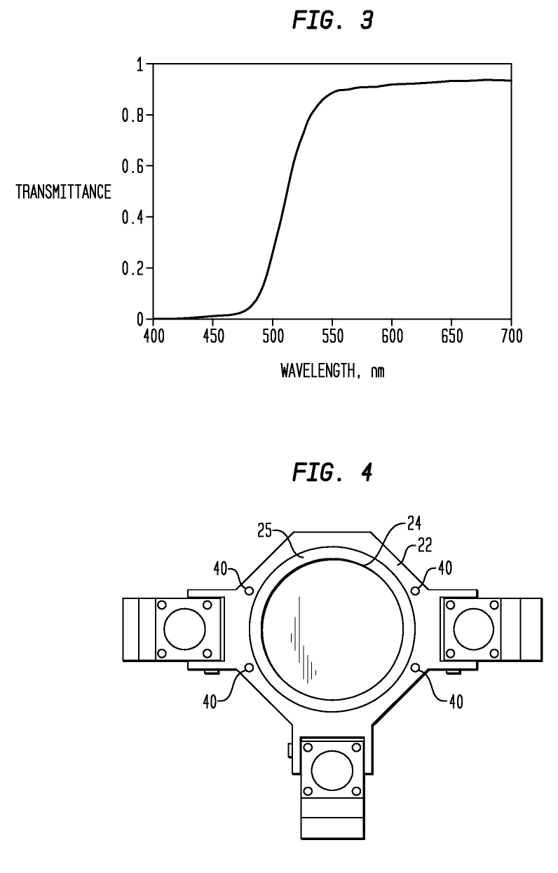

The main body 22 of the fluorescence exciting illumination adapter 10 has a hole 24 that fits around the stereomicroscope barrel 12 (shown in FIG. 1). The main body 22 may have one or more holes 26 that are that are adapted to accommodate thumbscrews (not shown), or other suitable fastening mechanisms, that may, for instance, be threaded, spring-loaded or a sliding friction fit, such that they can be used to removably attach the fluorescence exciting illumination adapter 10 to the stereomicroscope barrel 12 (shown in FIG. 1). There may also be an optional spacer ring 25 to enable the illumination adapter 10 to fit more closely on a stereomicroscope barrel 12 of smaller diameter. Spacer rings 25 (shown in FIG. 3) of varying inner diameters would enable an illumination adapter 10 with fixed inner diameter to work with a wider range of stereomicroscopes 14.

In a preferred embodiment, the main body 22 has brackets 28 that hold the illuminator assemblies 30. Each illuminator assembly 30 may be mounted to a bracket 28 by a machine screw 32 that passes through a hole 34 in the back of the illuminator assembly 30. Such a mounting arrangement allows the illuminator assemblies 30 to pivot relative to the main body 22. In this way the while light source and the light source capable of exciting fluorescence are rotatably attached to the rigid frame, or main body 22, on an axis that is offset and orthogonal to the axis of the cylindrical opening 24. In this way, the light sources are capable of positional adjustment so as to illuminate an object being imaged by the stereomicroscope for all magnifications that the stereomicroscope is capable of imaging.

A barrier filter 36 may be removably attached to the underside of the adapter main body 22. A light shield 38 may also be made of barrier filter material, and may be attached to the back of the central pivoting illuminator element 30 to act as a light shield so that the stereomicroscope user does not directly view the intense illumination on the specimen.

Each illuminator assembly 30 houses one or more light sources capable of exciting fluorescence. In a preferred embodiment, these light sources capable of exciting fluorescence are suitable Light Emitting Diodes (LED)s capable of exciting fluorescence such as, but not limited to, the Luxeon™ Royal Blue 3W Star LED's (product code LXHL-LR3C) supplied by Lumileds Lighting, LLC of San Jose, Calif. These LED's emit up to 340 mW of radiation with peak emission at approximately 455 nm wavelength (in the blue portion of the spectrum) in a Lambertian radiation pattern. In addition each illuminator assembly 30 houses a lens or reflector focusing element to direct the LED illumination onto the specimen.

The barrier filter 36 is made of material that has spectral characteristics such that it absorbs excitation light that is reflected from the specimen, transmitting only the stimulated fluorescence. By looking at the specimen through the light shield 38 the user may view the fluorescence of the specimen directly, without magnification.

The excitation radiation from a blue LED may, for instance, be absorbed by a yellow filter material that has maximum absorption in the blue (400 to 500 nanometers) visible light region, and a minimum absorption in the green-to-red (500 to 700 nanometers) visible light region. An example of such filter material suitable for use as a barrier filter 36 and the light shield 38 is the Tiffen™ Yellow 12 “minus blue” glass filter material as supplied by the Tiffen Company of Hauppauge, N.Y. or CYRO 430-7 yellow acrylic material as supplied by CYRO Industries of Rockaway, N.J. FIG. 3 show the spectral transmission characteristics for a representative yellow filter.

FIG. 4 illustrates the underside of the main body 22 showing a plurality of small magnets 40 inset into the main body 22. Suitable magnets include, but are not limited to, rare earth disc magnets such as, for instance, a 6.35 mm diameter by 2.54 mm thick Neodymium-Iron-Boron (NdFeB) disc magnet having a pull force of 971 g (2.14 lb).

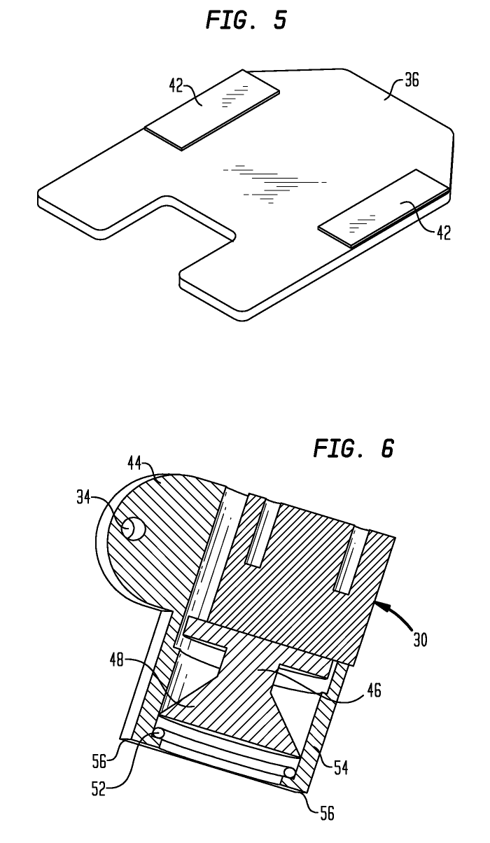

FIG. 5 illustrates the barrier filter element 36 with strips 42 of a metal that can be attracted by the magnets 40. In normal use, when the barrier filter 36 is brought in close proximity to the underside of the main body 22 the metal strips 42 will be attracted to and held in place by the inset magnets 40.

FIG. 6 shows a side cross-sectional view of one of the illuminator assemblies 30. The body 44 is made of a thermally conductive material such as aluminum to dissipate the heat generated by the LED 46. A thermally conducting grease (not shown) would be spread between the LED 46 and the illuminator assembly body 44 to assist in heat transfer. A hole 34 is provided at the back of the body 44 for the screw 32 that will be used to attach the illuminator assembly 30 to the main body 22, and about which the illuminator assembly 30 will pivot. A focusing optic 48 is positioned directly in front of the LED 46 to produce a narrow beam of intense illumination. An optional filter element 50 is positioned in front of the focusing optic 48. For the LEDs used for fluorescence excitation this filter 50 might be included to limit the range of wavelengths emitted. A compressive ring 52 such as a rubber o-ring is positioned in front of the filter so that when the cover 54 is installed with its mounting screws 56 the optical elements (46, 48, 50, 52) will be pressed firmly against the illuminator body 44.

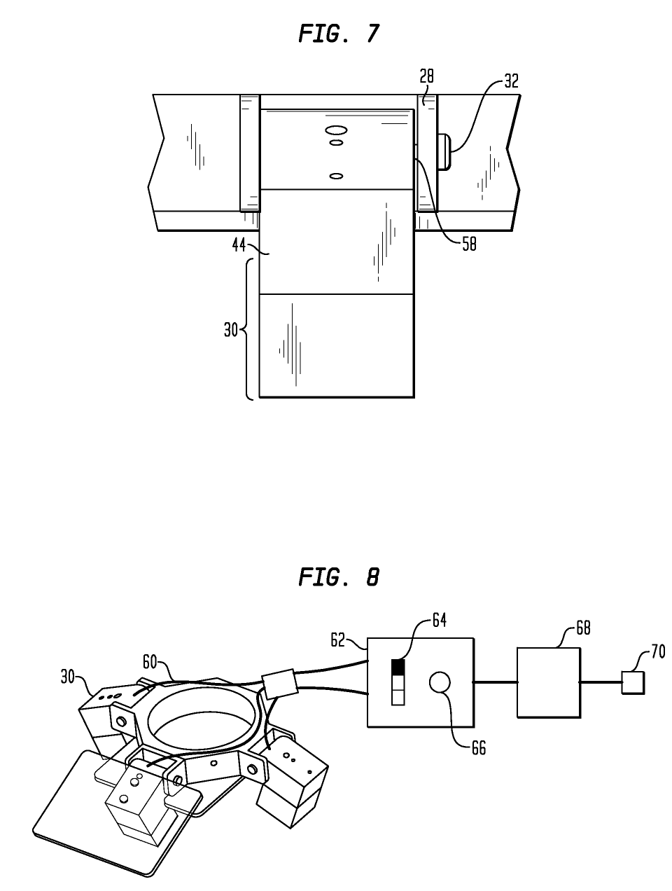

FIG. 7 illustrates an elevational view of one of the illuminator assemblies 30 mounted in its bracket 28 by the machine screw 32 that serves both as a means attach the elements together and as an axis about which the illuminator assembly 30 is able to pivot. A wave washer 58 or equivalent is positioned between the body 44 of the illuminator assembly 30 and the bracket 28. This wave washer 58 is in compression so that it presses against the surfaces of the body 44 and the bracket 28 with sufficient force so that when the illuminator assembly 30 is manually pivoted to some angle it will stay there by means of the compressive force.

FIG. 8 is a schematic drawing showing the adapter connected to a control box 62 and power supply 68.

Electrical wires 60 lead from the illuminator assemblies 30 to the control box 62 that includes switch 64 that can select fluorescence excitation, white-light illumination, or a combination of the two and a potentiometer 66 to selectively control the intensity of the white-light illumination. The control box can be powered either by a power supply 68 that plugs into conventional power distribution circuits by means of plug 70, or by batteries (not shown). In an further embodiment of the invention, the intensity of the white light may be controlled by a means other than a potentiometer, such as, but not limited to well known light dimmer circuits using thyristor and/or triac components.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention

What is claimed is:

1. A fluorescence illumination adapter, comprising:
a body element capable of removable attachment to a barrel of a first stereomicroscope;
a light source capable of exciting fluorescence in a specimen being imaged by said first stereomicroscope, said light source being attached to said body element;
a white light source capable of illuminating said specimen, said white light source being attached to said body element; and
an emission barrier filter, substantially opaque to electromagnetic radiation emitted by said light source capable of exciting fluorescence, and removably attached to said body element such that, when attached, said electromagnetic radiation emitted by said light source is substantially prevented from entering the imaging optics of said first stereomicroscope.

2. The device of claim 1 further comprising an insert element removably located adjacent to said body element such that said combination of said insert element and said body element is capable of removable attachment to a lower barrel of a second stereomicroscope having a smaller diameter than said lower barrel of said first stereomicroscope.

3. The device of claim 1 further wherein said body element further comprises a fastening element selected from the group comprising a set screw, a thumbscrew and a spring-loaded tensioning element, or a combination thereof.

4. The device of claim 1 wherein said body element comprises a rigid frame having an upper surface, a lower surface and a substantially circular cylindrical opening connecting said upper and lower surfaces, said cylindrical opening being a sliding fit to said barrel of said first stereomicroscope.

5. The device of claim 4 wherein said light source capable of exciting fluorescence is rotatably attached to said rigid frame on an axis offset and orthogonal to the axis of said cylindrical opening, such that said light source capable of exciting fluoresence is capable of positional adjustment to illuminate an object being imaged by said stereomicroscope for all magnifications said stereomicroscope is capable of imaging.

6. The device of claim 5 wherein said white light source is rotatably attached to said rigid frame on an axis offset and orthogonal to the axis of said cylindrical opening, such that said white light source is capable of positional adjustment to illuminate an object being imaged by said stereomicroscope for all magnifications said stereomicroscope is capable of imaging.

7. The device of claim 6 further including one or more magnets for removably attaching said emission barrier filter to said lower surface of said body element.

8. The device of claim 7 further including a second emission barrier filter located to be capable of acting as a light shield for the observer.

9. The device of claim 1 wherein said light source for exciting fluorescence is a light emitting diode and said white light source is a light emitting diode.

10. The device of claim 1 further comprising a potentiometer for controlling the intensity of said white light source.

11. A fluorescence illumination adapter, comprising:
a body element;
means for removably attaching said body element to a barrel of a first stereomicroscope;
a light source means for exciting fluorescence;
means for attaching said light source means to said body element such that said light source is rotabably adjustable to illuminate an object being imaged by said first stereomicroscope for all magnifications said first stereomicroscope is capable of imaging;
a white light source means for illuminating said object being imaged;
means for attaching said white light source to said body element such that said light source is rotabably adjustable to illuminate an object being imaged by said first stereomicroscope for all magnifications said first stereomicroscope is capable of imaging;
an emission barrier filter means for filtering substantially all said electromagnetic radiation emitted by said light source means for exciting fluorescence; and
attachment means for removably attaching said emission barrier filter means to said body element.

12. The device of claim 11 further comprising means for removably attaching said body element to a lower barrel of a second stereomicroscope having a smaller diameter than said lower barrel of said first stereomicroscope.

13. The device of claim 11 further comprising means for adjusting the intensity of said white light means.
